(19) United States
(12) Patent Application Publication
(10) Pub. No.: US 2023/0075736 A1
(43) Pub. Date: Mar. 9, 2023

(54) Systems and Methods for Self-Adapting Neutralization Against Cyber-Faults

(71) Applicant: GENERAL ELECTRIC COMPANY, Schenectady, NY (US)

(72) Inventors: Subhrajit ROYCHOWDHURY, Cohoes, NY (US); Masoud ABBASZADEH, Clifton Park, NY (US); Georgios BOUTSELIS, Niskayuna, NY (US); Joel MARKHAM, Niskayuna, NY (US)

(73) Assignee: GENERAL ELECTRIC COMPANY, Schenectady, NY (US)

(21) Appl. No.: 17/406,246

(22) Filed: Aug. 19, 2021

(51) Int. Cl. G06F 21/54; G06F 21/55; G06F 21/57; G05B 19/048

(52) U.S. Cl. CPC G06F 21/54; G06F 21/554; G06F 21/577; G05B 19/048

(57) ABSTRACT

The present disclosure provides techniques for implementing self-adapting neutralization against cyber-faults within industrial assets. The disclosed neutralization techniques may include obtaining an input dataset from a plurality of nodes of industrial assets and reconstructing compromised nodes in the plurality of nodes to neutralize cyber-faults detected based on the input dataset. A confidence metric may be computed for the reconstruction of the compromised nodes, e.g., using inductive conformal prediction. Based on the confidence metric and the reconstruction of the compromised nodes, input signals from the reconstruction of the compromised nodes may be transformed, or configuration parameters for a controller of the industrial assets may be tuned.

### TECHNICAL FIELD

The disclosed implementations relate generally to cyber-physical systems and more specifically to neutralization of faults in cyber-physical systems.

### BACKGROUND

Neutralization of cyber-faults (cyberattacks or system faults) in a cyber-physical system including industrial assets is critical to maintain resiliency and safe operation of the industrial assets in the interim period while awaiting more comprehensive actions. Typically, neutralization is achieved by virtual reconstruction of nodes (e.g. sensors, actuators, system or control parameters related to the industrial assets) that are determined to be compromised by leveraging a healthy or uncompromised set of nodes. The reconstructed nodes are in turn used by a controller in the cyber-physical system to maintain a stable closed loop operation of the system. However, the accuracy of the reconstruction of the compromised nodes may vary widely depending on several conditions. For example, extrapolation from a training set, uncertainty or sensitivity of a model used in the system, etc. may affect the accuracy of the reconstruction of the compromised nodes. In the worst case, a highly inaccurate reconstruction can push the entire system towards instability when used with the same controller parameters that are used for processing healthy inputs.

### SUMMARY

Accordingly, there is a need for systems and methods for self-adapting neutralization against cyber-faults. The techniques described herein use conformal prediction methods to predict a confidence metric of reconstruction for compromised nodes along with reconstructed signals representing the reconstructed nodes. The confidence metric may be leveraged to either retune parameters of a controller controlling assets of the cyber-physical system or transform the reconstruction signals suitably to avoid pushing the system into instability for inaccurate reconstructions. For example, the techniques described herein may be used to generate a confidence score to reflect the accuracy of reconstruction. In one aspect, the reconstructed signals that are to be provided or fed to the controller are suitably transformed based on the associated confidence score.; e.g., for a relatively high confidence number, the reconstructed signals are fed back almost unchanged, whereas for a relatively low confidence number, instead of the reconstructed signal, a signal close to the last healthy value may be fed back to the controller. In another aspect, the controller parameters may be suitably tuned based on the confidence score associated with the reconstruction; e.g., for a relatively high confidence number, tuning parameters for the controller may be left unchanged, whereas for a relatively low confidence number, the tuning parameters may be changed to make the controller action less aggressive. The techniques described herein may serve as an add-on module to traditional neutralization methods to improve their efficacy.

In one aspect, some implementations include a computer-implemented method of self-adapting neutralization against cyber-faults within industrial assets. The method may include reconstructing compromised nodes in a plurality of nodes (e.g., sensors, actuators, or controllers) of industrial assets to neutralize cyber-faults in the industrial assets. The method may also include computing a confidence metric for the reconstruction of the compromised nodes using inductive conformal prediction. The method may also include transforming input signals from the reconstruction of the compromised nodes or tuning configuration parameters for a controller of the industrial assets, or both, based on the confidence metric and the reconstruction of the compromised nodes.

In another aspect, a system configured to perform any of the above methods is provided, according to some implementations.

In another aspect, a non-transitory computer-readable storage medium has one or more processors and memory storing one or more programs executable by the one or more processors. The one or more programs include instructions for performing any of the above methods.

### BRIEF DESCRIPTION OF THE DRAWINGS

For a better understanding of the various described implementations, reference should be made to the Description of Implementations below, in conjunction with the following drawings in which like reference numerals refer to corresponding parts throughout the figures.

FIG. 1 shows a block diagram of an example system for neutralization against cyber-faults in industrial assets, according to some implementations.

FIG. 2 shows a block diagram of an example system for self-adapting neutralization against cyber-faults in industrial assets, according to some implementations.

FIG. 3 is a block diagram of an example system for adaptive neutralization of cyber-attacks, according to some implementations.

FIG. 4 shows a flowchart of an example method for self-adapting neutralization against cyber-faults for industrial assets, according to some implementations.

### DESCRIPTION OF IMPLEMENTATIONS

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are only used to distinguish one element from another. For example, a first electronic device could be termed a second electronic device, and, similarly, a second electronic device could be termed a first electronic device, without departing from the scope of the various described implementations. The first electronic device and the second electronic device are both electronic devices, but they are not necessarily the same electronic device.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

Neutralization modules are critical for responding to cyber-faults as they help maintain stability and safe operation of an industrial asset in the interim until a more comprehensive solution is available. Closing the operational loop of the cyber-physical system with inaccurate reconstruction of compromised nodes to neutralize a cyber-fault may lead to system instability. Assigning a confidence metric or score for reconstruction helps calibrate the control system to use the reconstructed signals by either transforming the signals and/or adjusting the tuning parameters to avoid instability for inaccurate reconstructions. Different systems and methods for neutralization are described in U.S. Patent Application Publication No. 2021/0120031, titled “Dynamic, Resilient Sensing System for Automatic Cyber-Attack Neutralization,” U.S. Patent Application Publication No. 2021/0126943, titled “Virtual Sensor Supervised Learning for Cyber-Attack Neutralization,” and U.S. Pat. No. 10,771,495, titled “Cyber-Attack Detection And Neutralization,” each of which is incorporated herein by reference. The common paradigm across all the methods is that the compromised nodes are reconstructed based on the uncompromised nodes and a pretrained neutralization model.

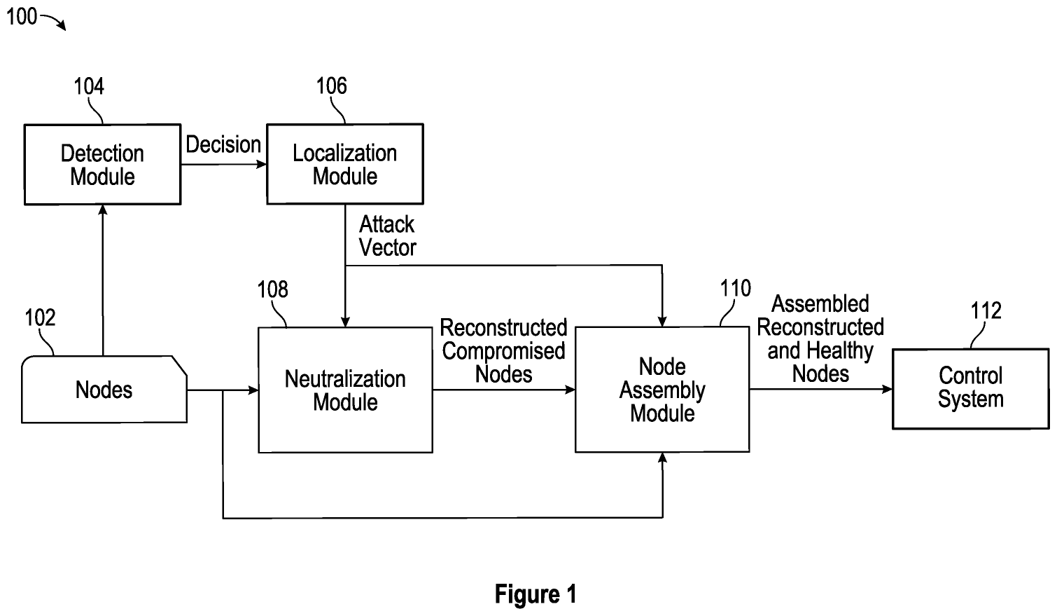

FIG. 1 shows a block diagram of an example system 100 (e.g., a cyber-physical system) for neutralization of cyber-attacks, according to some implementations. FIG. 1 shows how a neutralization module 108 interacts with other modules to maintain stability of the system 100. The system 100 may include industrial assets, such as gas turbine engines, wind turbine engines, steam turbines, heat recovery steam generators, balance of plant, healthcare machines and equipment, aircraft, locomotives, oil rigs, manufacturing machines and equipment, textile processing machines, chemical processing machines, mining equipment, and the like. The industrial assets may be co-located or geographically distributed and deployed over several regions or locations (e.g., several locations within a city, one or more cities, states, countries, or even continents). Each industrial asset may include nodes 102, such as sensors, actuators, controllers, software nodes. Each node may generate a series of monitoring node values over time representing current operation of the industrial asset. The nodes 102 may not be physically co-located or may be communicatively coupled via a network (i.e., wired or wireless network, such as an IoT over 5G, 6G or Wi-Fi 6). The nodes 102 are communicatively coupled to a neutralization module 108 and a detection module 104 (e.g., via communication link(s) that may include wired or wireless communication network connections, such as an IoT over 5G, 6G or Wi-Fi 6).

During operation, a windowed node vector X∈ [symbol] ^{n×w}, where n is an integer representative of the total number of nodes and w is an integer representative of a chosen window length of node values generated by the respective node, is sent to the detection module 104 to obtain an attack decision indicating that one or more nodes has been attacked or compromised by a cyber threat or is experiencing a failure. During real-time threat detection, decisions may be made by comparing where each point falls with respect to a decision boundary that separates the space between two regions (or spaces): abnormal (“attack” or “fault”) space and normal operating space. If the point falls in the abnormal space, the industrial asset is undergoing an abnormal operation such as during a cyber-attack. If the point falls in the normal operating space, the industrial asset is not undergoing an abnormal operation such as during a cyber-attack. Appropriate decision zone with boundaries are constructed using data sets as described herein with high fidelity models. For example, support vector machines may be used with a kernel function to construct a decision boundary. According to some embodiments, deep learning techniques may also be used to construct decision boundaries. The decision in turn is sent to a localization module 106 which, in case of an attack, designates the attacked nodes. In some implementations, a module computes a probability that a node is attacked and a the neutralization may engage on that data.

The localization module 106 is configured to analyze the attack decisions received from the detection module 104 and produce an output such as an attack vector that identifies which nodes may be compromised. In some implementations, the localization module 106 may use an automatic localization method based on dynamic modeling of features in time, using data-driven system identification approaches over time series, estimating the identified model outputs, and comparing the estimated output to a threshold, which is a multi-dimensional decision boundary. This process may be done in parallel for all monitoring nodes. Each node whose estimated outputs pass its corresponding decisions boundary, may be reposted as anomalous. For the case of multiple anomalies present, using a post-processing technique, the localization module may determine whether each anomaly is an independent attack or a dependent attack as a result of previous anomalies propagated through the closed-loop feedback control system. The automated attack localization system may consist of off-line (training) and online (operation) modules. During the training phase (off-line), normal and attack data sets are used to create local decision boundaries in the feature space using data-driven learning methods such as support vector machines. Features are extracted from data using the feature engineering module outlined in U.S. Pat. No. 10,771,495, titled “Cyber-Attack Detection And Neutralization,” which is incorporated herein in its entirety.

The number of features used for each boundary is selected based on optimizing the detection rate and false alarm rate. The feature extraction and boundary generation process are performed individually on each and every monitoring node. In a similar fashion, features are extracted to be used for dynamic system identification as values of features evolve over time. The features used for dynamic modeling are from the normal data set (or a data set generated from the models with attacks and normal operational behavior). Features extracted from the normal data sets, using a sliding time window over the time-series data in the physical space to create new time series of feature evolution in the feature space. Then, the feature time series are used for dynamic modeling. The dynamic models are in the state space format. A multivariate vector autoregressive model (VAR) may be used for fitting dynamic models into feature time series data. Then using the dynamic models identified in the training phase, the output of each model is estimated using stochastic estimation techniques, such as Kalman filtering. The covariance matrix of the process noise needed for the stochastic estimator is readily available here as Q, which is computed during training phase. Then the output of each stochastic estimator is compared against its corresponding local decision boundary, also computed and pre-stored during the training phase. Each monitoring nodes whose estimated features are violating the corresponding decision boundary is reported as being attacked.

In the next stage, the system post-processes the localized attack and determines whether the detected attack is an independent attack or it is an artifact of the previous attack through propagation of the effects in the closed-loop feedback control system. This provides additional information and insight and it is useful in case of multiple attacks detected.

The output localization module 106 may be encoded in terms of the attack vector, which is a vector with binary entries. An entry of 0 at a location of the attack vector denotes the node at that index is a healthy node, whereas a 1 indicates an compromised node at that index. The attack vector thus partitions the node vector X into two vectors: a compromised node vector X_{c}∈ [symbol] ⁿ^{_{c}}^{×w}, and a healthy node vector Xₕ∈ [symbol] ⁿ^{ₕ}^{×w}. Here, n_{c} and nₕ are the number of compromised and healthy nodes, respectively, with n_{c}+nₕ=n. Example operations of the detection and localization modules can be found in U.S. Application Publication No. US2020/0099707, titled “Hybrid Learning System for Abnormality Detection And Localization”, U.S. Pat. No. 10,417,415, titled “Automated Attack Localization And Detection”, U.S. Pat. No. 10,819,725, titled “Reliable Cyber-Threat Detection in Rapidly Changing Environments”, and U.S. Patent Application Publication No. 2019/0058715, titled “Multi-Class Decision System for Categorizing Attack and Fault Types”, each of which is incorporated herein by reference in its entirety.

Based on the trained model and associated methodologies in the neutralization module 108 (see U.S. Pat. No. 10,771,495, titled “Cyber-Attack Detection And Neutralization”, and U.S. Patent Application Publication No. 2021/0182385, titled “Dynamic, Resilient Virtual Sensing System and Shadow Controller for Cyber-Attack Neutralization”, which are incorporated by reference in their entirety), the neutralization module 108 reconstructs the compromised nodes as X′_{c}∈ [symbol] ⁿ^{_{c}}^{×w}.

A node assembler 110 (sometimes called a node assembly module) then assembles the reconstructed and healthy nodes, partitions the windowed vector to take only the current time instant and sends the assembled node vector X∈ [symbol] ⁿ to a controller 112 (sometimes called a control system).

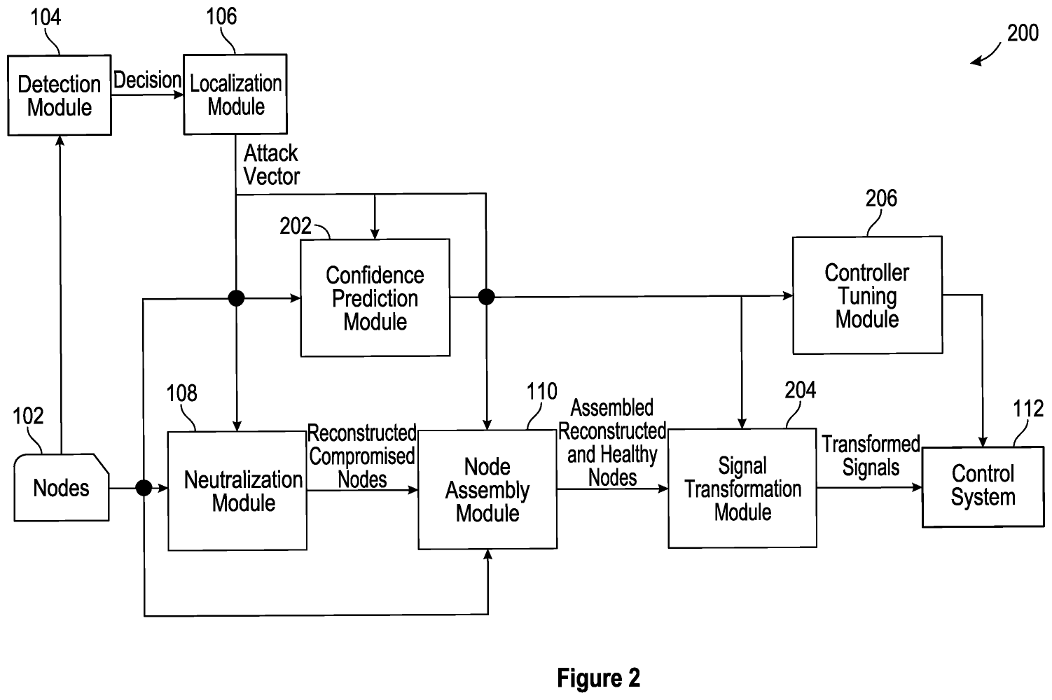

A potential issue with some techniques for detection and neutralization may be that the stability of the system during neutralization depends heavily on the accuracy of the reconstructed signal X′_{c}. An inaccurate reconstruction can happen due to various reasons, such as extrapolation beyond training space, sparsity in training space, model uncertainty, local sensitivity variation and so on. The inaccurate reconstruction can significantly deteriorate the performance of the control system 112 and could push the control system 112 to instability. To address this issue, a confidence metric of reconstruction may be computed based on which either a) the signal Xₐ may be transformed before sending to the controller 112 and/or b) the controller 112 gains may be tuned accordingly to accommodate a lower confidence (as indicated by a relatively low confidence metric value). An example architecture 200 that implements this methodology is shown in FIG. 2, according to some implementations. Details of the sub-modules are described below in the following subsections. FIG. 2 includes the nodes 102, detection module 104, localization module 106, neutralization module 108, node assembly module 110 and control system 112 from FIG. 1, and additionally includes a confidence prediction module 202, a signal transformation module 204 and a controller tuning module 206, for computing and leveraging reconstruction accuracy.

### EXAMPLE CONFIDENCE PREDICTION MODULE

In some implementations, the confidence prediction module 202 predicts a metric, which can either be a scalar or a scalar associated with each reconstructed node, that indicates the accuracy of the reconstruction. Accuracy of reconstruction can suffer due to various reasons, including extrapolation from training dataset, sparsity in training data, uncertainty in the model and so on. The confidence number may be derived using conformal prediction techniques, which assess or use historical data to determine a confidence interval. For every prediction, the probability of error e is given by a confidence interval Γ^{e}. The terms confidence number, confidence metric, score, number, and metric are equivalent. If the conformal prediction model has seen a similar datapoint as the predicted value in the past, then the interval for a given error eₛ would be narrow indicating a relatively high confidence of prediction. Otherwise, for example in cases of sparsity or extrapolation, the confidence interval would be wider, indicating a lower confidence in prediction.

To obtain the confidence number, the confidence prediction module 202 may use inductive conformal prediction methodology. To derive the predictor, a training set S is split into two random subsets D₁ and D₂. A model for neutralization [symbol] is trained on D₁ and a suitable residual metric [symbol] is defined on D₂ based on [symbol] . An example of [symbol] is the norm valued function of the vector of residuals. Suppose [symbol] set is the set of all residuals over D₂ and qₐ is the a quantile of [symbol] . Under the theory of inductive conformal prediction, the predictor over the entire set S is given by [symbol] ±qₐ, where q ₐ denotes the uncertainty in prediction.

This methodology can be extended to different subsets of the training set, and a qₐ can be obtained for each of the subsets. Depending on the nature of the residual distributions, prediction confidences would vary with the corresponding qₐ of the subset in which the run-time sample belongs. If physics knowledge for the system is available, the choice of subsets can be guided by the physics, such as steady state, fast or slow rising, or falling transient and so on. Otherwise, clustering methods can be used to determine the suitable choice of subsets. For sparse regions in the training set or outside the training set, the value of residual metric [symbol] and hence qₐ would be inherently high, giving rise to a higher uncertainty and hence lower confidence in predictions. The description below describes how the confidence metric can be used by other modules, e.g., signal transformation module 206 and controller tuning module 206, of the system 200.

### EXAMPLE SIGNAL TRANSFORMATION MODULE

A goal of the signal transformation module 204 is to feedback appropriate signal levels (e.g., from the node assembly module 110) to the controller or control system 112 to maintain safe and stable operation. For cases where the reconstruction accuracy is high, as indicated by the confidence predictor, the transformation module 204 may act as a pass-through between the neutralization module 108 and the control system 112. However, for potentially inaccurate reconstructions, passing the signal directly to the controller 112 may jeopardize the stability of the controller 112. In such scenarios, the signal transformation module 204 may modify the signals to an appropriate value to ensure stability is maintained.

One example method for the transformation is to use a transformation function gₖ: [symbol] ^{w}^{₁}× [symbol] ^{w}^{₂}× [symbol] → [symbol] , which takes as input the reconstructed signal over a window of w₁ samples, the last known good value of a raw signal (from the system) that kept the controller stable over an window of w₂ samples, and a suitable norm a obtained through a norm function [symbol] : [symbol] ⁿ^{_{c}}→ [symbol] from the confidence vector C∈ [symbol] ⁿ^{_{c}}, and produces a suitable signal value for that instant. In one embodiment, the transformation function may be a linear sliding function between the reconstructed and last known good signal, with a lower confidence metric pushing it towards the later. In another embodiment, the transformation function may be a linear or nonlinear machine learning model (such as a neural network) which is trained on a suitable dataset to obtain the best representation of gₖ. If a high definition simulation model exists, or lots of data can be gathered from the field, using a gₖ, trained via supervised learning would be a more suitable choice. Even in the absence of a simulation model, if enough data is present to safely deploy an approximate gₖ, reinforcement learning method in field can be employed to make it better over time.

### EXAMPLE CONTROLLER TUNING MODULE

A goal of the controller retuning module 206 (sometimes called the controller tuning module) is to tune the controller or control system 112 based on the reconstruction confidence during neutralization to maintain stability and safety in scenarios where the reconstruction accuracy may be low. Depending on the confidence vector C∈ [symbol] ⁿ^{_{c}} that is produced by the confidence predictor module 202, the controller parameters may be tuned to be less aggressive than its normal tuning. In the context of the instant disclosure, “aggressiveness” of tuning of the controller parameters may relate to the rate at which the controller parameters are adjusted in responding to changes in the system. For example, a relatively more aggressive tuning mean that the parameters are so adjusted that the controller responds to changes at a relatively faster rate and tries to compensate for them quickly. Such aggressive tuning, however, may have a downside of overcorrecting, and if the information based on which the controller is acting is not good, overcorrection may lead to undesirable oscillations and instability. On the other hand if a controller is slow to respond to changes, it may take time to reach a steady state, but would be less prone to error in the information as the changes are small and the controller has more time to correct itself. Accordingly, the controller parameters may be adjusted to make the controller more or less aggressive.

A suitable norm function [symbol] : [symbol] ⁿ^{_{c}}→ [symbol] may transform the confidence vector to an appropriate scalar a. a may be then used to retune the tuning parameters using an appropriate set of scalar valued function ƒₖ: [symbol] → [symbol] , where ƒₖ is applied to tune the k^{th} controller parameter. If sufficient knowledge about the controller tuning is available, the controller parameter tuning vector β∈ [symbol] ^{p}, where p is the number of tuning parameters, may be directly tuned from the confidence vector C using a set of vector values function Gₙ_{_{c}}: [symbol] ⁿ^{_{c}}→ [symbol] ^{p}.

In some implementations, the controller tuning module retunes the controller parameters in such a way to ensure that the control system 112 responds to the error signals in a milder fashion for a lower confidence metric. In a typical PID controller, this would amount to reducing the gains of the controller to ensure no oscillations happen in case the estimates are inaccurate, as indicated by the confidence predictor. For a high confidence metric, the tuning may be left unchanged, which may result in sub-optimal performance (e.g., reduced speed or more fuel burn in a gas turbine) over the neutralization period, but the asset would have greater chance to maintain safe and stable operation.

In some implementations, in response to a low confidence reconstruction, the controller structure may be switched as opposed to simply changing the tuning parameters as outlined in this disclosure. Such a switching controller approach may be suitable for certain systems, but the generalizability would be low.

In this way, the techniques described above can be used to maintain safe operation of industrial assets under cyber-fault, in the interim until a more comprehensive remedial action is available, thereby reducing downtime/restart of the assets and associated costs. The techniques can also be used to safeguard systems against instability in case of inaccurate neutralization, thus expanding the safe operating regime under cyber-faults. Furthermore, the techniques can be used as an add-on to existing neutralization modules, thereby making it suitable for retrofitting. The example architecture described above is scalable thereby making it suitable for both unit level and fleet level deployment.

### EXAMPLE COMPUTING DEVICE OR SERVER FOR ADAPTIVE NEUTRALIZATION

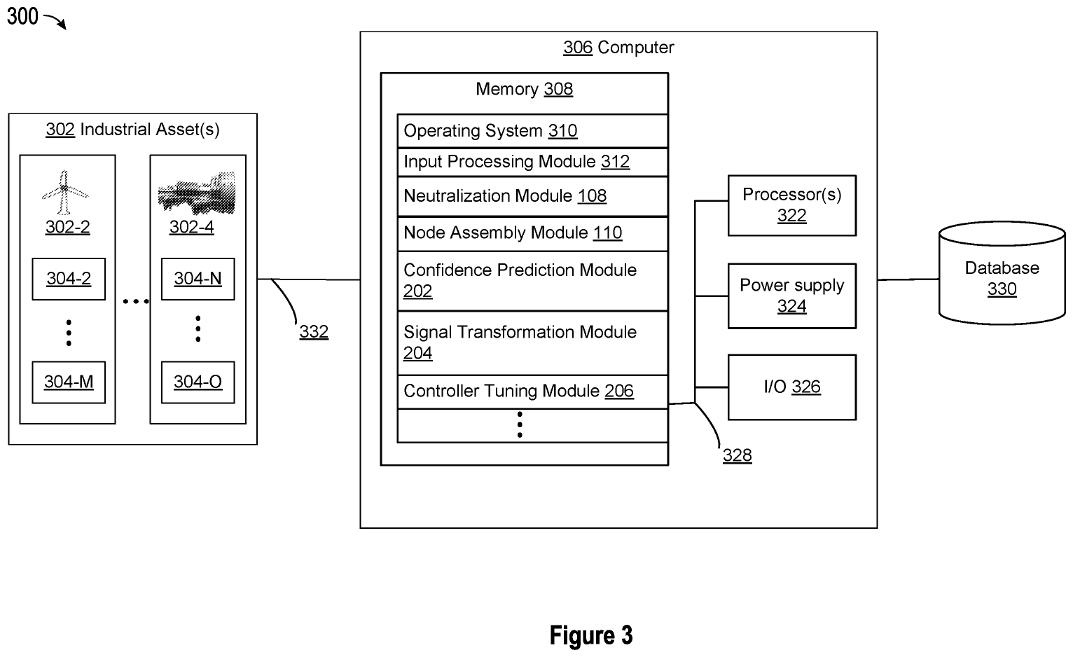

FIG. 3 is a block diagram of an example system 300 for adaptive neutralization of cyber-attacks, according to some implementations. The system 300 includes one or more industrial assets 302 (e.g., a wind turbine engine 302-2, a gas turbine engine 302-4) that include nodes 302 (e.g., the nodes 102, nodes 304-2, . . . , 304-M, and nodes 304-N, . . . , 304-O). In practice, the industrial assets 302 may include an asset community including several industrial assets. It should be understood that wind turbines and gas turbine engines are merely used as non-limiting examples of types of assets that can be a part of, or in data communication with, the reset of the system 300. Examples of other assets include steam turbines, heat recovery steam generators, balance of plant, healthcare machines and equipment, aircraft, locomotives, oil rigs, manufacturing machines and equipment, textile processing machines, chemical processing machines, mining equipment, and the like. Additionally, the industrial assets may be co-located or geographically distributed and deployed over several regions or locations (e.g., several locations within a city, one or more cities, states, countries, or even continents). The nodes 304 may include sensors, actuators, controllers, software nodes. The nodes 304 may not be physically co-located or may be communicatively coupled via a network (i.e., wired or wireless network, such as an IoT over 5G). The industrial assets 302 are communicatively coupled to a computer 306 via communication link(s) 332 that may include wired or wireless communication network connections, such as an IoT over 5G.

The computer 306 typically includes one or more processor(s) 322, a memory 308, a power supply 324, an input/output (I/O) subsystem 326, and a communication bus 328 for interconnecting these components. The processor(s) 322 execute modules, programs and/or instructions stored in the memory 308 and thereby perform processing operations, including the methods described herein.

In some implementations, the memory 308 stores one or more programs (e.g., sets of instructions), and/or data structures, collectively referred to as “modules” herein. In some implementations, the memory 308, or the non-transitory computer readable storage medium of the memory 308, stores the following programs, modules, and data structures, or a subset or superset thereof:
an operating system 310;
an input processing module 312 that accepts signals or input datasets from the industrial assets 302 via the communication link 332. In some implementations, the input processing module accepts raw inputs from the industrial assets 302 and prepares the data for processing by other modules in the memory 308;
the neutralization module 108;
the node assembly module 110;
the confidence prediction module 202;
the signal transformation module 204; and
the controller tuning module 206.

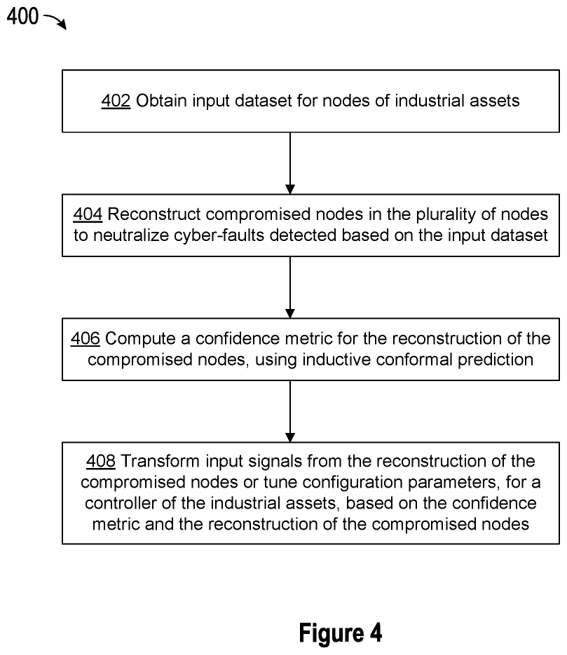

Details of operations of the above modules are described above in reference to FIGS. 1 and 2, and further described below in reference to FIG. 4, according to some implementations.

The above identified modules (e.g., data structures, and/or programs including sets of instructions) need not be implemented as separate software programs, procedures, or modules, and thus various subsets of these modules may be combined or otherwise rearranged in various implementations. In some implementations, the memory 308 stores a subset of the modules identified above. In some implementations, a database 330 (e.g., a local database and/or a remote database) stores one or more modules identified above and data associated with the modules. Furthermore, the memory 308 may store additional modules not described above. In some implementations, the modules stored in the memory 308, or a non-transitory computer readable storage medium of the memory 308, provide instructions for implementing respective operations in the methods described below. In some implementations, some or all of these modules may be implemented with specialized hardware circuits that subsume part or all of the module functionality. One or more of the above identified elements may be executed by the one or more of processor(s) 322.

The I/O subsystem 326 communicatively couples the computer 306 to any device(s), such as servers (e.g., servers that generate reports), and user devices (e.g., mobile devices that generate alerts), via a local and/or wide area communications network (e.g., the Internet) via a wired and/or wireless connection. Each user device may request access to content (e.g., a webpage hosted by the servers, a report, or an alert), via an application, such as a browser. In some implementations, output of the computer 306 (e.g., output generated by the controller tuning module 206) is communicated to the control system 112 for tuning one or more controllers of the industrial assets 302.

The communication bus 328 optionally includes circuitry (sometimes called a chipset) that interconnects and controls communications between system components.

FIG. 4 shows a flowchart of an example method 400 for self-adapting neutralization against cyber-faults for industrial assets, according to some implementations. The method 400 can be executed on a computing device (e.g., the computer 306) that is connected to industrial assets (e.g., the assets 302). The method includes obtaining (402) an input dataset (e.g., using the module 312) from a plurality of nodes (e.g., the nodes 304; e.g., sensors, actuators, or controllers) of industrial assets. The method also includes reconstructing (404) compromised nodes in the plurality of nodes reconstructing (e.g., using a neutralization module 108 and/or the node assembly module 110) to neutralize cyber-faults detected based on the input dataset. The method also includes computing a confidence metric (e.g., using the confidence prediction module 202) for the reconstruction of the compromised nodes, using inductive conformal prediction. The method also includes transforming (408) input signals (e.g., using the signal transformation module 204) from the reconstruction of the compromised nodes or tuning (e.g., using the controller tuning module 206) configuration parameters, for a controller of the industrial assets, based on the confidence metric and the reconstruction of the compromised nodes.

In some implementations, computing the confidence metric by the confidence prediction module 202 includes: segmenting a training dataset S into two random subsets D₁ and D₂; reconstructing the compromised nodes using a model for neutralization [symbol] that is trained on D₁; computing a set of all residuals over D₂ and a quantile qₐ of a residual metric [symbol] . The residual metric is defined on D₂ based on [symbol] (the a quantile denotes an uncertainty in prediction); and defining the confidence metric over the input dataset S by [symbol] ±qₐ. In some implementations, the residual metric [symbol] is the norm valued function of the set of all residuals. In some implementations, the method further includes: defining a plurality of subsets of the random subset D₂; computing a respective a quantile for each subset of the plurality of subsets; and defining the confidence metric for each subset of the plurality of subsets based on its respective a quantile. In some implementations, the plurality of subsets is defined based on physics (e.g., steady state, fast/slow rising/falling, transient) of the industrial assets. In some implementations, the plurality of subsets is defined using clustering methods (sparse regions in the training set or regions outside the training set have high a quantile and high residual metric [symbol] , giving rise to a higher uncertainty and hence lower confidence in predictions). Clustering is a specific way to implement unsupervised learning to find neighborhoods in a dataset. In the absence of physics knowledge, that is the predominant way to find ‘data which are like’ and ‘data which are different’ within the same dataset. Example clustering methods include Gaussian mixture models, k means clustering, and DBSCAN.

In some implementations, transforming the input signals by the signal transformation module 204 includes computing signal values for the input dataset using a transformation function gₖ: [symbol] ^{w}^{₁}× [symbol] ^{w}^{₂}× [symbol] → [symbol] , which takes as input a reconstructed signal over a window of w₁ samples, a last known good value of the signal that kept the controller stable over a window of w₂ samples, and a suitable norm a obtained through a norm function [symbol] : [symbol] ⁿ^{_{c}}→ [symbol] from the confidence metric C∈ [symbol] ⁿ^{_{c}}, wherein [symbol] is the set of real numbers, and wherein n_{c} is the number of compromised nodes. Last known good value or state refers to states that did not set off any flags or alarms. Some implementations keep a finite buffer of previous states. Stability can be measured in various ways. In practical scenarios, one way of measuring stability online is by computing the strength of higher frequency components of a signal fast fourier transform (FFT) during steady state. If the system is stable, in steady state, the strength of the DC value would be much higher than the strength of high frequency components. However, if the system goes towards instability, it will start oscillating thereby increasing the strength of high frequency components of the FFT. Note that this is not a universal method, but one that is largely employed to detect system divergence in steady state. In some implementations, the norm function [symbol] is a linear sliding function that maps the reconstructed signal to the last known good value, with a lower confidence metric pushing the reconstructed signal towards the last known good signal. In some implementations, the norm function [symbol] is a non-linear machine learning model (e.g., a neural network) which is trained on a suitable dataset to obtain the best representation of gₖ. The term ‘best’ is determined based on the objective function. For the chosen objective function, the ‘best’ g_k is determined by the function that minimizes the objective. Whether the chosen objective function was ‘best’ or not, that is a different question and whose answer is typically confirmed by domain experts. In some implementations, the suitable dataset is obtained using a high definition simulation model or obtained from data gathered, during operation of the industrial assets, and gₖ is trained via supervised learning.

In some implementations, the suitable dataset has sufficient data for a safe approximation of gₖ, and gₖ is trained via reinforcement learning.

In some implementations, tuning configuration parameters of the controller by the controller tuning module 206 includes: transforming the confidence metric to an appropriate scalar a using a suitable norm function norm function [symbol] : [symbol] ⁿ^{_{c}}→ [symbol] , wherein [symbol] is the set of real numbers, and wherein n_{c} is the number of compromised nodes; and tuning the configuration parameters using an appropriate set of scalar valued functions fₖ: [symbol] → [symbol] where fₖis applied to tune the k^{th} controller parameter. In some implementations, tuning configuration parameters of the controller includes: tuning controller parameter tuning vector β∈ [symbol] ^{p}, from the confidence metric C, using a set of vector valued functions Gₙ_{_{c}}: [symbol] ⁿ^{_{c}}→ [symbol] ^{p} (e.g., neural networks approximating nonlinear functions). p is the number of tuning parameters. In some implementations, tuning configuration parameters of the controller includes adjusting the configuration parameters such that the controller responds to the faults in a milder fashion for a lower value of the confidence metric than for a higher value of the confidence metric. For example, if the neutralization is confident in its decision, it will tune the controller aggressively as it can push the performance with a lower margin, whereas for low confidence it has to allow for a higher margin of error and cannot push the performance aggressively. In some implementations, the controller is a PID controller, and wherein tuning configuration parameters of the controller includes reducing gains of the controller to ensure no oscillations happen in case the confidence metric indicates estimates are inaccurate. In a typical PID controller, this would amount to reducing the gains of the controller to ensure no oscillations happen in case the estimates are inaccurate, as indicated by the confidence predictor. For a high confidence metric, the tuning may be left as is. As previously mentioned, this may result in sub-optimal performance (e.g., reduced speed or more fuel burn in a gas turbine) over the neutralization period, but the asset would have greater chance to maintain safe and stable operation.

In some implementations, the compromised nodes are reconstructed based on uncompromised nodes without the faults and a pretrained neutralization model.

In some implementations, the method further includes outputting, to the controller 112, signals obtained from assembling the compromised nodes with the faults and healthy nodes without the faults.

In some implementations, the method further includes detecting and localizing (e.g., using the detection module 104 and the localization module 106) the cyber-faults including: obtaining a windowed node vector X∈ [symbol] ^{n×w} from the input dataset, where n is the total number of nodes and w is a predetermined window length; and encoding the faults as an attack vector of binary entries. An entry of 0 at a location of the attack vector denotes the node at that index is healthy and an entry of 1 indicates an uncompromised node at that index, thereby partitioning the node vector X into two vectors including a compromised node vector X_{c}∈ [symbol] ⁿ^{_{c}}^{×w} and a healthy node vector Xₕ∈ [symbol] ⁿ^{ₕ}^{×w}, where n_{c} and nₕ are the number of compromised nodes and health nodes, respectively, and n_{c}+nₕ=n. In some implementations, reconstructing the compromised nodes includes outputting, to the controller, an assembled node vector Xₐ∈ [symbol] ⁿ that is obtained by assembling the compromised node vector X_{c} and the healthy node vector Xₕ, including slicing the windowed node vector to obtain signals corresponding to a current time instant.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations are chosen in order to best explain the principles underlying the claims and their practical applications, to thereby enable others skilled in the art to best use the implementations with various modifications as are suited to the particular uses contemplated.

What is claimed is:

1. A method of self-adapting neutralization against cyber-faults for industrial assets, the method comprising:
obtaining an input dataset from a plurality of nodes of industrial assets, wherein the plurality of nodes are physically co-located or communicatively coupled via a wired or wireless network;
reconstructing, using a neutralization and node assembly module, compromised nodes in the plurality of nodes to neutralize cyber-faults detected based on the input dataset;
computing, using a confidence prediction module, a confidence metric for the reconstruction of the compromised nodes; and
transforming, using a signal transformation module, input signals from the reconstruction of the compromised nodes or tuning, using a controller tuning module, configuration parameters, for a controller of the industrial assets, based on the confidence metric and the reconstruction of the compromised nodes.

2. The method of claim 1, wherein the confidence metric is based on a training dataset.

3. The method of claim 2, wherein computing the confidence metric comprises:
segmenting the training dataset S into two random subsets D₁ and D₂;
reconstructing the compromised nodes using a model for neutralization [symbol] that is trained on D₁;
computing a set of all residuals over D₂ and a quantile qₐ of a residual metric [symbol] , wherein the residual metric [symbol] is defined on D₂ based on [symbol] ; and
defining the confidence metric over the training dataset S by [symbol] ±qₐ.

4. The method of claim 3, wherein the residual metric [symbol] is the norm valued function of the set of all residuals.

5. The method of claim 3, further comprising:
defining a plurality of subsets of the random subset D₂;
computing a respective a quantile for each subset of the plurality of subsets; and
defining the confidence metric for each subset of the plurality of subsets based on its respective a quantile.

6. The method of claim 5, wherein the plurality of subsets is defined using clustering methods.

7 The method of claim 1, wherein transforming the input signals comprises:
computing signal values for the input dataset using a transformation function gₖ: [symbol] ^{w}^{₁}× [symbol] ^{w}^{₂}× [symbol] → [symbol] , which takes as input a reconstructed signal over a window of w₁samples, a last known good value of a raw signal that kept the controller stable over a window of w₂ samples, and a suitable norm a obtained through a norm function [symbol] : [symbol] ⁿ^{_{c}}→ [symbol] from the confidence metric C∈ [symbol] ⁿ^{_{c}}, wherein [symbol] is the set of real numbers, and wherein n_{c} is the number of compromised nodes.

8. The method of claim 7, wherein the norm function [symbol] is a linear sliding function that maps the reconstructed signal to the last known good value, with a lower confidence metric pushing the reconstructed signal towards the last known good signal.

9. The method of claim 7, wherein the norm function [symbol] is a non-linear machine learning model which is trained on a suitable dataset to obtain the best representation of gₖ.

10. The method of claim 9, wherein the suitable dataset is obtained using a high definition simulation model or obtained from data gathered, during operation of the industrial assets, and gₖ is trained via supervised learning.

11. The method of claim 9, wherein the suitable dataset has sufficient data for a safe approximation of gₖ, and gₖ is trained via reinforcement learning.

12. The method of claim 1, wherein tuning configuration parameters of the controller comprises:
transforming the confidence metric to an appropriate scalar a using a suitable norm function norm function [symbol] : [symbol] ⁿ^{_{c}}→ [symbol] , wherein [symbol] is the set of real numbers, and wherein n_{c} is the number of compromised nodes; and
tuning the configuration parameters using an appropriate set of scalar valued functions fₖ: [symbol] → [symbol] , where fₖ is applied to tune the k^{th} controller parameter.

13. The method of claim 12, wherein tuning configuration parameters of the controller comprises:
tuning controller parameter tuning vector β∈ [symbol] ^{p}, from the confidence metric C, using a set of vector valued functions Gₙ_{_{c}}: [symbol] ⁿ^{_{c}}→ [symbol] ^{p}, wherein p is the number of tuning parameters.

14. The method of claim 13, wherein tuning configuration parameters of the controller comprises:
adjusting the configuration parameters such that the controller responds to the faults in a milder fashion for a lower value of the confidence metric than for a higher value of the confidence metric.

15. The method of claim 14, wherein the controller is a PID controller, and wherein tuning configuration parameters of the controller comprises:
reducing gains of the controller to ensure no oscillations happen in case the confidence metric indicates estimates are inaccurate.

16. The method of claim 1, wherein the compromised nodes are reconstructed based on uncompromised nodes without the faults and a pretrained neutralization model.

17. The method of claim 1, further comprising:
outputting, to the controller, signals obtained from assembling the compromised nodes with the faults and healthy nodes without the faults.

18. The method of claim 1, further comprising detecting and localizing the cyber-faults comprising:
obtaining a windowed node vector X∈ [symbol] ^{n×w} from the input dataset, where n is the total number of nodes and w is a predetermined window length; and
encoding the faults as an attack vector of binary entries, wherein an entry of 0 at a location of the attack vector denotes the node at that index is healthy and an entry of 1 indicates an uncompromised node at that index, thereby partitioning the node vector X into two vectors including a compromised node vector X_{c}∈ [symbol] ⁿ^{_{c}}^{×w} and a healthy node vector Xₕ∈ [symbol] ⁿ^{×w}, where n_{c} and nₕ are the number of compromised nodes and health nodes, respectively, and n_{c}+nₕ=n.

19. The method of claim 18, wherein reconstructing the compromised nodes comprises:
outputting, to the controller, an assembled node vector Xₐ∈ [symbol] ⁿ that is obtained by assembling the compromised node vector X_{c} and the healthy node vector Xₕ, including slicing the windowed node vector to obtain signals corresponding to a current time instant.

20. A non-transitory computer-readable storage medium storing one or more programs for execution by one or more processors of an electronic device, the one or more programs including instructions for:
obtaining an input dataset from a plurality of nodes of industrial assets, wherein the plurality of nodes are physically co-located or communicatively coupled via a wired or wireless network;
reconstructing, using a neutralization and node assembly module, compromised nodes in the plurality of nodes to neutralize cyber-faults detected based on the input dataset;
computing, using a confidence prediction module, a confidence metric for the reconstruction of the compromised nodes, using inductive conformal prediction; and
transforming, using a signal transformation module, input signals from the reconstruction of the compromised nodes or tuning, using a controller tuning module, configuration parameters, for a controller of the industrial assets, based on the confidence metric and the reconstruction of the compromised nodes;

21. A system for implementing self-adapting neutralization against cyber-faults for industrial assets, comprising:
one or more processors;
memory; and
one or more programs stored in the memory, wherein the one or more programs are configured for execution by the one or more processors and include instructions for:
obtaining an input dataset from a plurality of nodes of industrial assets, wherein the plurality of nodes are physically co-located or communicatively coupled via a wired or wireless network;
reconstructing, using a neutralization and node assembly module, compromised nodes in the plurality of nodes to neutralize cyber-faults detected based on the input dataset;
computing, using a confidence prediction module, a confidence metric for the reconstruction of the compromised nodes, using inductive conformal prediction; and
transforming, using a signal transformation module, input signals from the reconstruction of the compromised nodes or tuning, using a controller tuning module, configuration parameters, for a controller of the industrial assets, based on the confidence metric and the reconstruction of the compromised nodes.
